(19) United States
(12) Patent Application Publication
(10) Pub. No.: US 2012/0222877 A1
(43) Pub. Date: Sep. 6, 2012

(54) HAND TOOL TELEACTUATING POLE CONTROLLED BY A THRUST TOWARDS THE SUPPORT MATERIAL

(75) Inventors: Patrick Herelier, Saint Jean de Muzols (FR); Emmanuel Vallon, Portes les Valence (FR); Ludovic Rousson, Saint Lager Bressac (FR); Jean-Luc Simonin, Barcelonne (FR); Guy Jaillet, La Roche de Glun (FR)

(73) Assignee: Societe de prospection Et D'Inventions Techniques Spit, Bourg-les-Valence (FR)

(21) Appl. No.: 13/509,088

(22) PCT Filed: Nov. 15, 2010
(86) PCT No.: PCT/IB10/55176

§ 371 Date: May 10, 2012

(30) Foreign Application Priority Data
Nov. 13, 2009 (FR) 0905477

(51) Int. Cl. B25C 7/00

(52) U.S. Cl. 173/18

(57) ABSTRACT

The pole comprises a securing end, with tool securing means and tool actuating means, a gripping end to be gripped by an operator, and telecontrolling means for telecontrolling the actuating means. The actuating means are arranged in the tool securing means to be directly controlled by the pole securing end and thus telecontrolled by the pole and its gripping end under the action of a thrust of the pole towards the support material. The pole is well adapted to sealing guns.

The field of the invention according to the present application is securing nail or staple type elements by means of a hand actuated tool, but in a support material remote from the operator and being inaccessible for his tool, even held at arm's length.

The herein-mentioned support material is for example a ceiling.

The also herein-mentioned hand actuated tool is of a securing element driving device type for an indirect shot, with a plunger propelled forward under the action of the combustion of a powder charge or the explosion of a flammable gas blend, for driving a securing element.

The invention aims at avoiding the operator to have to climb on a chair, a stool or other ladder, for being able to actuate his tool in good stability and posture conditions.

In the case of an indirect shot device, actuating is to be understood as actuating the device trigger. Trigger should be understood as any igniting means.

The present invention relates to a teleactuating pole for a hand tool comprising a securing end, with tool securing means and tool actuating means, and a gripping end to be gripped by an operator, and telecontrolling means for telecontrolling the actuating means.

EP 1,486,294 discloses a teleactuating pole which comprises, for the actuating step, a linkage inside the pole and a sleeve sliding on the pole and which can be made integral with the linkage by means of a key. It is an actuating mechanism that could be brittle, able to become jammed, being not of an attractive price and not of a common use.

Therefore, the invention of the present application aims at providing a more satisfactory pole in all those respects.

Thus, the present application relates to a teleactuating pole for a hand tool to be placed in abutment against a support material, the pole comprising a securing end, with means for securing the tool and means for actuating the tool, a gripping end able to be gripped by an operator, and telecontrolling means for telecontrolling the actuating means, the pole being characterized in that the actuating means are arranged in the tool securing means to be directly controlled by the pole securing end and thus to be telecontrolled by the pole and its gripping end under the action of a pole thrust towards the support material.

The invention is outstanding by its implementation simplicity, by simply moving the pole. A first thrust of the pole towards the support material, or receptor, abuts the tool against the material, before a second thrust, thus in the same direction, controls the actuating means.

In the preferred embodiment of the pole of the invention, the pole securing end is slidably mounted in a tool securing and actuating shoe, the actuating means comprise a traction cable being integral, at one end, with the pole securing end and, at the other end, with an actuating finger movingly mounted in the direction opposed to the support material against the action of return means towards the support material and under the sliding action of the pole securing end towards the support material.

This invention will be better understood by means of the following description of a preferred embodiment of the pole according to the invention, referring to the appended drawings, wherein:

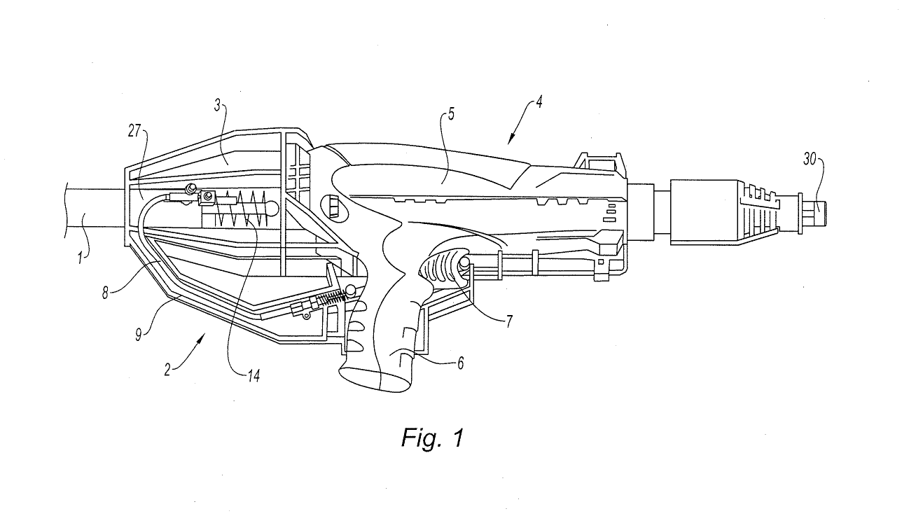

FIG. 1 is a view of the pole securing end and the securing and actuating shoe, with a securing tool secured on the shoe at rest;

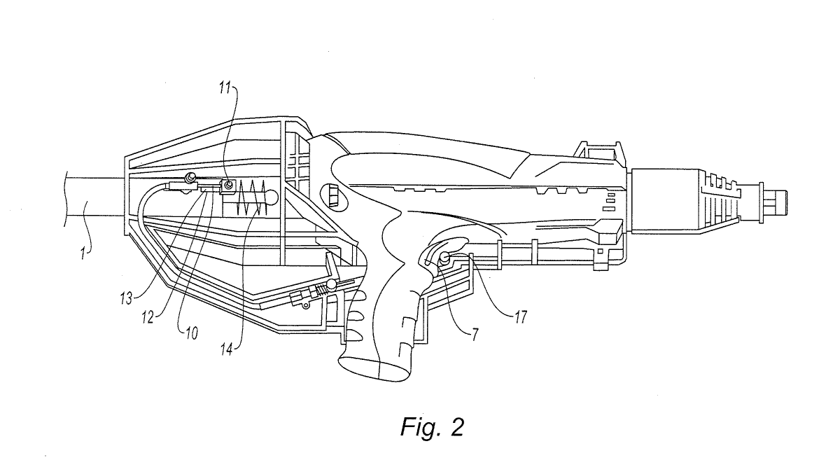

FIG. 2 is a view similar to FIG. 1, but while shooting;

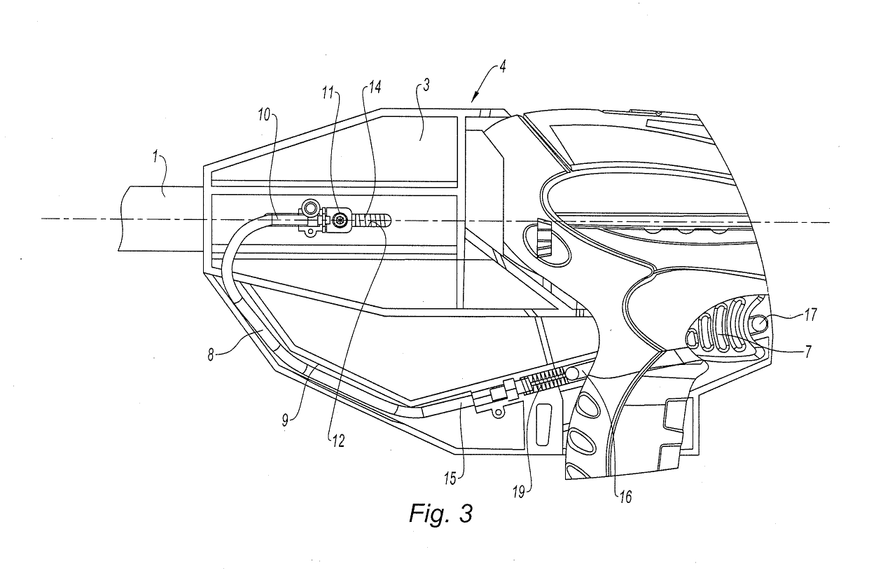

FIG. 3 is a view similar to FIG. 1, but more detailed;

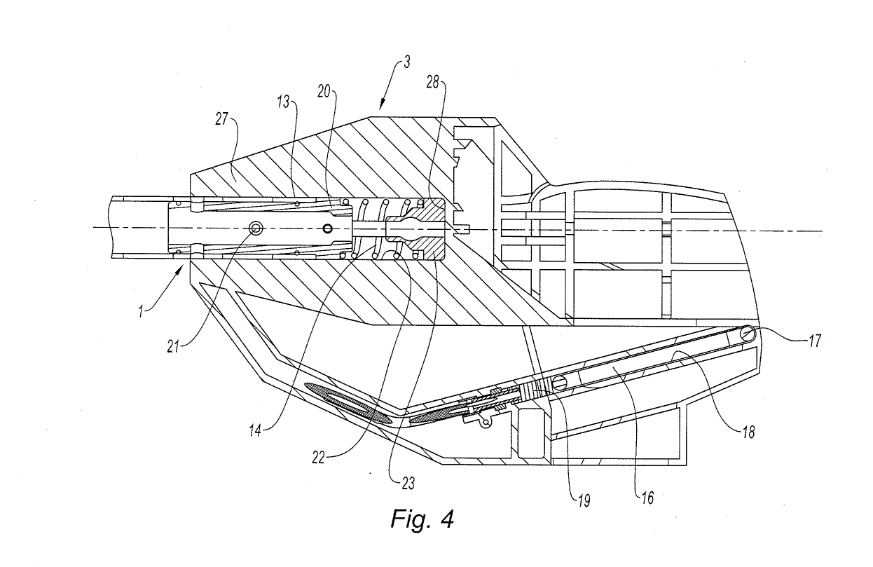

FIG. 4 is a detailed axial section view of the securing pole and shoe, before shooting;

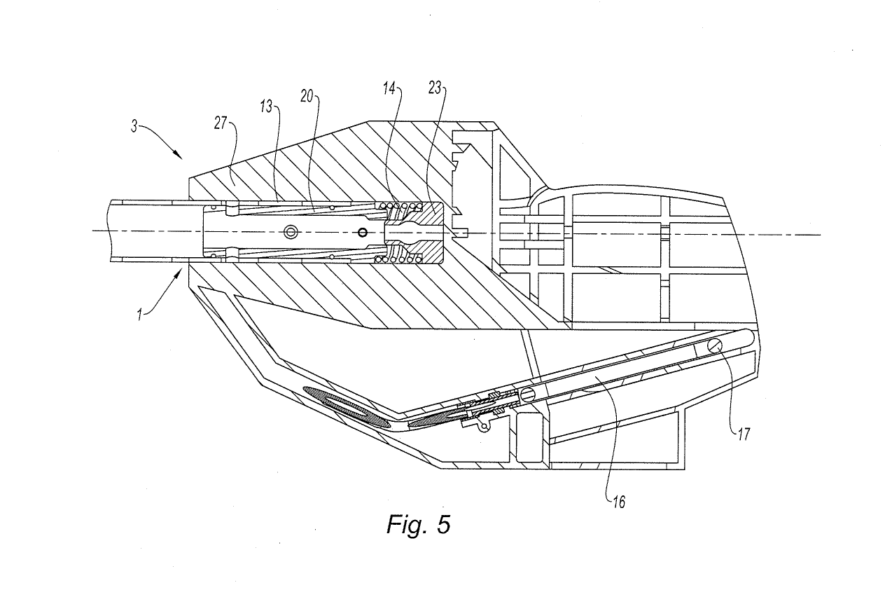

FIG. 5 is a view similar to FIG. 4, but while shooting; and

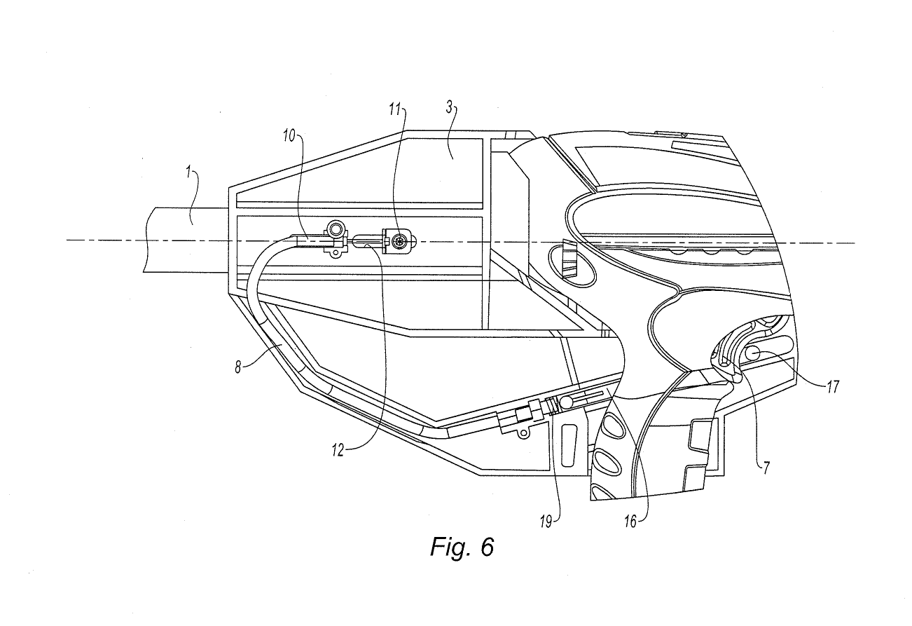

FIG. 6 is a view similar to FIG. 3, but while shooting.

The pole which will now be described can be integral with or can comprise a plurality of lengths linked telescopically together or assembled end to end, for instance through screwing. The pole comprises a gripping end to be gripped by an operator, and a securing end portion 1 mounted to slide in a securing and actuating shoe 2. The shoe 2 comprises here a monobloc part 3. The shoe 2 receives here a hand tool, in that case a sealing gun 4, arranged in appropriate recesses of the half-shells.

The tool 4 conventionally comprises a body 5, a handle 6 and at the junction of both, a trigger 7. Its tip guide 30, at the front, is to be put against the support material in order to be able to perform a shooting.

The tool triggering 7 is performed by means, here, a traction cable 8. The cable extends in a groove 9 of the half-shell 3. One of the ends 10 of the cable 8 is secured to a small yoke 11 which is itself, through an oblong light 12 arranged in part 27 of the shoe 2, within which the pole securing end portion 1 can slide, secured to the end 13 of this end portion 1. This pole securing end portion 1 can slide forward of the tool against the action of a return spring 14. The other of the ends 15 of the cable 8 is secured to an actuating length 16 bearing an actuating finger 17 opposite to the cable and length securing. The length 16 may slide in the groove 18 in the opposed direction at the front of the tool 4 under the action of a cable 8 traction and against the action of a spring 19, intended to bring back the finger 17 and the length 16 to the front of the tool 4, as well as against the action of the spring 14.

The pole is a tubular element and, particularly, the securing end portion 1 thereof. An end sleeve 20, also tubular, is fitted into the end 13 of this end portion 1 and secured to it by keying. The yoke 11 is secured to this sleeve 20 in 21. The end 13 of the pole end portion 1 is slidably mounted in a bore 22 arranged in the part 27 of the shoe 2. In the bottom 28 of this bore 22 a small pedestal 23 is arranged. The return spring 14 is abutted, by its both ends, against the sleeve 20 and the pedestal 23.

The pole end sleeve 20, on one hand, and the cable 8 and the length 16, with its finger 17, on the other hand, all these means being arranged in the securing shoe 3, form the actuating means of the trigger 7 in the gun 4. They are directly controlled by the securing end 13 of the pole end portion 1 and thus by its gripping end simply by a thrust of this pole to the front of the gun, and thus towards the support material against which the gun is abutting while shooting, said thrust leading the sliding of the sleeve 20 inside the bore 22 of the securing shoe 3, against the action of the spring 14. The pedestal 23 enters inside the sleeve 20 (FIG. 5). The yoke 11 being thus driven to the front of the gun (FIG. 6), drives the end 10 of the cable 8 and thus the cable 8 thus slidably pulling the length 16 inside the groove 18, in a direction opposed to the front of the gun, against the action of the return spring 19, that moves the finger 17 actuating the trigger 7.

A pole of the same axis as the gun to be actuates has been described. One could imagine a pole being shifted with respect to the gun and shoe axis.

Furthermore, instead of the traction cable, rods or other equivalent means of that type could be imagined.

1. A teleactuating pole for a hand tool to be arranged in abutment against a support material, the pole comprising a securing end, with means for securing the tool and means for actuating the tool, a gripping end able to be gripped by an operator, and telecontrolling means for telecontrolling actuating means, the pole being characterized in that the actuating means are arranged in the tool securing means to be directly controlled by the pole securing end and thus to be telecontrolled by the pole and its gripping end under the action of a pole thrust towards the support material.

2. A pole according to claim 1, wherein the pole securing end is slidably mounted in a tool securing and actuating shoe.

3. A pole according to claim 2, wherein the actuating means comprise a traction cable being integral, at one end, with the pole securing end and, at the other end, with an actuating finger movably mounted in a direction opposed to the support material.
